(19) United States
(12) Patent Application Publication
(10) Pub. No.: US 2018/0156257 A1
(43) Pub. Date: Jun. 7, 2018

(54) HIGH-STRENGTH LIGHTWEIGHT SCREW HAVING A DOUBLE CONTOUR ENGAGEMENT

(71) Applicant: KAMAX Holding GmbH & Co. KG, Homberg (Ohm) (DE)

(72) Inventors: Reiner Rühl, Ulrichstein (DE); Thorsten Schmitt, Laubach (DE); Gunther Hartmann, Alsfeld (DE); Manuel Kellner, Alsfeld-Altenburg (DE); Klaus-Günter Vennemann, Waidring/Tirol (AT)

(21) Appl. No.: 15/828,798

(22) Filed: Dec. 1, 2017

(30) Foreign Application Priority Data
Dec. 2, 2016 (DE) 10 2016 123 318.8

(51) Int. Cl. F16B 23/00

(52) U.S. Cl. CPC F16B 23/0038; F16B 23/0061

(57) ABSTRACT

A high-strength screw (1) includes a head (2) having a tool engagement external contour (7) and a tool engagement internal contour (8). For example, the tool engagement external contour (7) is an external hexagonal and the tool engagement internal contour (8) is an internal hexagonal. A plurality of additional pocket-shaped impressions (13) are arranged in the tool engagement internal contour (8) between corners (12).

### CROSS REFERENCE TO RELATED APPLICATIONS

This application claims priority to co-pending German Patent Application No. DE 10 2016 123 318.8 filed Dec. 2, 2016.

### FIELD OF THE INVENTION

The invention relates to a high-strength screw including a head having a tool engagement contour.

Usually, screws either have a tool engagement external contour or a tool engagement internal contour.

### BACKGROUND OF THE INVENTION

A wheel screw including a head having a tool engagement external contour is known from German utility model DE 20 2008 016 808 U1. The tool engagement external contour is designed as an external six-edge (external hexagonal). A central polygonal impression is arranged radially inward in the head, the impression not forming a tool engagement contour. The material being displaced from the region of the impression during manufacture of the screw by deforming serves to fill the corners of the external hexagonal.

A screw including a head having a tool engagement external contour and a tool engagement internal contour is known from German patent application DE 100 46 562 A1 corresponding to US patent application No. US 2003/004257 A1. The tool engagement external contour belongs to the geometry type six-round (internal hexalobular). The tool engagement internal contour belongs to the geometry type six-round, six-edge or multi-tooth.

A screw having a tool engagement internal contour is known from European patent application EP 1 987 792 A1 corresponding to U.S. Pat. No. 9,554,837 B2. The screw in the region of its head includes a clamping portion being radially compressable due to the arrangement of at least one slot. The compressions serves to insert the screw with its clamping portion into a support.

An actuation tool for actuating a screw having a tool engagement internal contour is known from German patent application DE 10 2007 036 529 A1.

### SUMMARY OF THE INVENTION

The invention relates to a high-strength screw including a head having a tool engagement external contour and a tool engagement internal contour, wherein pocket-shaped impressions are arranged in the tool engagement internal contour.

The invention also relates to a deforming method for automatic manufacture of a high-strength screw from a blank by deforming the blank in a deforming tool such that a head of a screw including a tool engagement external contour, a tool engagement internal contour and pocket-shaped impressions in the tool engagement internal contour are produced.

The invention also relates to a deforming tool for manufacturing a high-strength screw of a blank, comprising a stamp tool and a matrix tool being designed and arranged such that they, when the deforming tool is actuated, deform the blank such that a head of a screw having a tool engagement external contour, a tool engagement internal contour and pocket-shaped impressions in the tool engagement internal contour are formed.

The invention furthermore relates to an actuation tool for actuating a high-strength screw having a tool engagement external contour and a tool engagement internal contour. The actuation tool includes an external actuation element for engaging the tool engagement external contour of the head of the screw and an internal actuation element for simultaneously engaging the tool engagement internal contour of the head of the screw.

### Definitions

High-strength screw: In this application, a high-strength screw is to be understood as a screw having a tensile strength Rₘ of at least 800 N/mm². Typical high-strength screws belong to the property classes 8.8, 10.9 or 12.9. However, the high-strength screw according to the invention may also be an ultra-high-strength screw having a tensile strength Rₘ of at least 1400 N/mm². The “high-strength” screw according to the invention is thus at least a high-strength screw, but it can also be an ultra-high-strength screw.

Tool engagement external contour: A tool engagement external contour is to be understood as a contour or shape being located radially outward at the head of the screw. An actuation tool engages the contour for actuating the screw. The contour is formed by a plurality of functional surfaces mostly being interconnected by corners or radiuses. In the technical field of the invention, a tool engagement external contour is often designated as “external force engagement” or “external force application”.

Tool engagement internal contour: A tool engagement internal contour is to be understood as a contour being arranged radially inward at the head of the screw. An actuation tool engages the contour for actuating the screw. The contour is formed by a plurality of functional surfaces mostly being interconnected by corners or radiuses. The tool engagement internal contour limits a central impression in the head of the screw in a radial direction. This central impression is to be differentiated from the pocket-shaped impressions being mentioned in this application. In the technical field of the invention, a tool engagement internal contour is often designated as “internal force engagement” or “internal force engagement”.

Multi-edge: In this application, a multi-edge is to be understood as a design of a tool engagement external contour (“external multi-edge”) or a tool engagement internal contour (“internal multi-edge”) in which the approximately plane functional surfaces of the sub-units of the multi-edge are interconnected within the sub-unit by a corner at an angle of 120°.

Multi-tooth: In this application, a multi-edge is to be understood as a design of a tool engagement external contour (“external multi-edge”) or a tool engagement internal contour (“internal multi-edge”) in which the approximately plane functional surfaces of the sub-units of the multi-tooth within the sub-unit are interconnected by a corner at an angle of 90°.

Multi-round: In this application, a multi-round is to be understood as a design of a tool engagement external contour (“external multi-round”) or a tool engagement internal contour (“internal multi-round”) in which the rounded functional surfaces are interconnected by round corners.

Geometry type: In this application, a geometry type is to be understood as the underlying to geometric shape of the tool engagement contour. Typical geometric shapes are multi-edge, multi-tooth and multi-round. In this sense, there is no differentiation between the external contour and the internal contour. This means that, for example, an external multi-tooth and an internal multi-tooth belong the same second geometry type and an external multi-round and an internal multi-round belong to the same third geometry type.

### Further Description

The new screw is a lightweight screw that can be variably and reliably actuated.

Due to the new design with a tool engagement external contour and a tool engagement internal contour, the mass and thus the weight of the screw is substantially reduced. Compared to a head only having a tool engagement external contour, the weight reduction may be approximately 30%.

Due to the introduction of the tool engagement internal contour during cold-forming, there is the problem that the outward corners of the tool engagement external contour are not completely filled with material. Instead of the desired comparatively sharp-edged transition between the force engagement surfaces, one attains an areal triangle at the upper end of the head. This reduces the height of the proper force engagement surfaces between the corners. This height is also designated as effective key height. It is then no longer possible to transmit the desired torque.

This undesired effect is counteracted by the new pocket-shaped impressions located in the force engagement surfaces of the tool engagement internal contour. The pocket-shaped impressions provide material which during cold-forming during manufacture of the head of the screw is dislocated from this region of the force engagement surface of the tool engagement internal contour and instead flows into the corners of the tool engagement external contour. This material is not required at this place of the force engagement surfaces of the tool engagement internal contour, and it is thus meaningfully used to improve the effectiveness of the tool engagement external contour for transmission of the desired torque.

However, the new high-strength screw is not only lightweight, but it allows for completely new ways of actuation. A first advantage is the increased flexibility. Depending on the mounting situation and/or the available tools, the screw can be tightened and untightened, respectively, by its tool engagement external contour or its tool engagement internal contour. A second advantage is the possibility of transmitting a greater torque by simultaneously actuating the screw by its tool engagement external contour and its tool engagement internal contour. A third advantage is the possibility of dimensioning the head of the screw such that an actuation is only possible when simultaneously using the tool engagement external contour and the tool engagement internal contour without damaging the tool engagement contour. This is a safety feature, for example to prevent theft of wheels of motor vehicles by respectively designed wheel screws. Another possible use are, for example, motor screws being designed in this way to prevent undesired manipulations at the motor of a motor vehicle.

The tool engagement internal contour may include force engagement surfaces each being interconnected by corners (“internal corners”). The corners each extend in a direction being approximately parallel to the direction of the axis of the screw. The pocket-shaped impressions may each be arranged approximately centrally between the corners. They may at least be arranged in the center between the corners and extend partly in both directions towards the next corner to the left and the next corner to the right. Due to the central arrangement, it is ensured that the material being displaced from the impressions during cold-forming uniformly fills the corners of the tool engagement external contour (“external corners”). At the same time, the required force engagement surfaces at the tool engagement internal contour are not affected.

The internal corners extend from the bottom of the central recess in the head of the screw to the upper free end of the head of the screw.

The central recess may have the shape of a truncated cone, and it may be tapered (narrowed) in a downward direction towards the shank of the screw. In this way, one also attains improved filling of the upper portion of the external corners.

In addition to the head, the screw includes a shank and a threaded portion having a thread. In an axial direction directly next to the head supporting surface of the head, there mostly is a threadless shank portion of a certain length. However, this shank portion may also have a minimal length or it may practically not exist. The screw may also be designed as a collar screw and thus include a collar adjacent to the head. The external corners and the internal corners usually do not extend over the collar. However, this could also be different.

The pocket-shaped impressions in the tool engagement internal contour may be directly connected to the axial end of the head facing away from the shank. In the other direction, they may extend to the bottom of the central recess in the head of the screw. In this way, the material volume required for filling the external corners is provided.

The pocket-shaped impressions in the tool engagement internal contour may each be arranged approximately centrally between the corners of the tool engagement external contour. The pocket-shaped impressions in the tool engagement internal contour may, however, instead be arranged radially inward with respect to the corners of the tool engagement external contour. The arrangement substantially depends on the respective combination of the tool engagement internal contour and the tool engagement external contour.

The number and arrangement of the pocket-shaped impressions may be chosen such that a pocket-shaped impression is arranged between two adjacent corners of the tool engagement external contour in a circumferential direction. However, it is also possible that the pocket-shaped impressions are not arranged between the corners, but instead radially inward with respect to the corners of the tool engagement external contour. They are then especially not arranged at each corner, but instead at every other corner. Such an arrangement is especially suitable when the number of corners of the tool engagement external contour is greater than the number of corners of the tool engagement internal contour.

The pocket-shaped impressions may be designed as cold-formed dents in the respective force engagement surface of the tool engagement internal contour. Especially in a lower portion towards the shank of the screw, they have an approximately elliptical or parabolic shape. In an upward direction, they are limited by the upper rim surface of the head.

The width of the pocket-shaped impressions may increase in the direction of the axial end of the head facing away from the shank.

The pocket-shaped impressions may not extend over the entire width of the respective force engagement surface of the tool engagement internal contour. They end clearly before the next corner such that it is ensured that the proper function of the force engagement surface is maintained.

The tool engagement internal contour may belong to the geometry type multi-edge, multi-tooth or multi-round. The multi-edge may be especially a standardized internal multi-edge such that it can be actuated by usual standard tools. Especially, it may be a six-edge (hexagon) or eight-edge (octagon). However, a low number of edges is preferred. The geometry form often designates as “four-edge” (square) by the skilled person has an angle of 90° between the functional surfaces such that it actually is no four-edge, but instead a four-tooth.

The multi-tooth may be especially a standardized internal multi-tooth such that it can be actuated by usual standard tools. However, it may also be a four-tooth (square), six-tooth or eight-tooth (double square). However, a low number of teeth is preferred.

The multi-round may be especially a standardized internal multi-round such that it can be actuated by usual standard tools. Especially, it may be a four-round (4-point star), five-round (5-point star), six-round (6-point star; hexalobular; 6lobe) or seven-round (7-point star). However, a low number of round corners is preferred.

When the tool engagement internal contour belongs to the geometry type multi-edge or multi-tooth, it includes plane force engagement surfaces (functional surfaces) each being interconnected by comparatively sharp-edged corners. However, when the tool engagement internal contour belongs to the geometry type multi-round, it includes rounded force engagement surfaces (functional surfaces) each being interconnected by rounded corners. The same applies to the tool engagement external contour.

The tool engagement external contour may belong to the geometry type multi-edge, multi-tooth or multi-round. Especially, the multi-edge may be a standardized external multi-edge such that it can be actuated by usual standard tools. Especially, it may be a six-edge, eight-edge, ten-edge or twelve-edge.

The multi-tooth may be especially a standardized external multi-tooth such that it can be actuated by usual standard tools. Especially, it may be a four-tooth, six-tooth, eight-tooth, ten-tooth or twelve-tooth.

The multi-round may be especially a standardized external multi-round such that it can be actuated with usual standard tools. Especially, it may be a five-round, six-round or seven-round.

The tool engagement external contour and the tool engagement internal contour may belong to the same geometry type. Especially, the may both belong to the geometry type edge, tooth or round. However, it is also possible that they belong to different geometry types. For example, the following combinations of an external contour and an internal contour are possible: edge/edge, tooth/tooth, round/round, edge/tooth and tooth/edge.

The combination of external contour and internal contour may be especially designed such that they have the same orientation. This means that at least a part of the external edges and of the internal edges are radially arranged with respect to one another.

Due to the new high-strength screw including a double contour engagement, the height of the head can be reduced compared to the prior art. The head may be especially as high as it is the case in a prior art screw having a thread being one or two dimensions smaller. The weight reduction resulting therefrom may be between approximately 25% and 35%, especially between approximately 26% and 31%.

The following table 1 lists values of the prior art according to the internal standard WA900 by FORD:

TABLE 1

| | | Effective head |
|---|---|---|
| Thread dimension | Key width (SW) | height (K′) |
| M6 | 8 | 2.9 |
| M8 | 10 | 3.8 |
| M10 | 13 | 4.3 |
| M12 | 15 | 5.4 |
| M14 | 18 | 5.6 |
| M16 | 21 | 6.8 |

The following table 2 lists respective values for a screw according to the invention with the goal of a maximum weight reduction:

TABLE 2

| Thread | Key width | Internal six-edge | Effective head |
|---|---|---|---|
| dimension | (SW) | impression (ISW) | height (K′) |
| M8 | 8 | 5 | 4.6 |
| M10 | 10 | 6 | 5.9 |
| M12 | 13 | 8 | 6.7 |
| M14 | 15 | 10 | 8.3 |
| M16 | 18 | 12 | 8.8 |
| M18 | 21 | 16 | 10.5 |

The following table 3 lists the respective values for a screw according to the invention with the goal of a minimal height of the head:

TABLE 3

| Thread | Key width | Internal six-edge | Effective head |
|---|---|---|---|
| dimension | (SW) | impression (ISW) | height (K′) |
| M6 | 8 | 5 | 2.3 |
| M8 | 10 | 6 | 2.9 |
| M10 | 13 | 8 | 3.3 |
| M12 | 15 | 10 | 4.1 |
| M14 | 18 | 12 | 4.4 |
| M16 | 21 | 16 | 5.2 |

The deforming method for mechanically (automatically) chipless manufacture of the high-strength screw may be especially a cold-forming method. The method is conducted by a deforming tool in a press, especially a multi-stage press.

For attaining the desired strength of the screw, the screw may be heat-treated during its manufacture. Heat-treatment may be especially austempering for producing a bainite structure. The deformation process for producing the thread may be especially rolling. This may especially be a cold-deforming process.

The starting material used for producing the high-strength screw is usually called “wire”. The wire used for the new high-strength screw may be made of cold formable non-hardened and non-tempered steel, and it may have a carbon content of approximately 0.2% to 0.6% or approximately 0.2% to 0.5%. The steel may include alloying elements, especially Cr, Mo, Mn, Ni, V, Nb or Ti with a total share of especially more than approximately 1.1%.

The actuation tool for actuating (turning; rotating) the screw having a double contour engagement is to be mounted in a screwing tool. The screwing tool may be especially motor-driven or hand-driven. The actuation tool includes a housing in which the external actuation element and the internal actuation element are arranged.

The internal actuation element may be supported in the housing by a spring to be movable in a translatory direction. In this case, the internal actuation element in its unbiased position protrudes from the housing in an axial direction. In this sense, it serves as introducing and centering aid during initiation of contact between the actuation tool and the head of the screw.

For example, this functionality of the actuation tool may be used in a sense that a contact is closed and an electrical signal is transmitted only after the end position has been reached against the force of the spring. The electrical signal leads to the motor of the screwing tool being turned on. In this way, actuation of the actuation tool causing the head of the screw to be damaged is prevented before complete contact between the external actuation element and the tool engagement external contour as well as between the internal actuation element and the tool engagement internal contour has been established.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIG. 1A illustrates a perspective view of a first exemplary embodiment of the new screw having a double contour engagement.

FIG. 1B illustrates a view of the head of the screw according to FIG. 1A from above.

FIG. 1C illustrates a partial sectional side view of the screw according to FIG. 1A.

FIG. 1D illustrates the detail A of FIG. 1C.

FIG. 2A illustrates a perspective view of a second exemplary embodiment of the new screw having a double contour engagement.

FIG. 2B illustrates a view of the head of the screw according to FIG. 2A from above.

FIG. 2C illustrates a partly sectional side view of the screw according to FIG. 2A.

FIG. 2D illustrates the detail A of FIG. 2C.

FIG. 3A illustrates a perspective view of a third exemplary embodiment of the new screw having a double contour engagement.

FIG. 3B illustrates a view of the head of the screw according to FIG. 3A from above.

FIG. 3C illustrates a partly sectional side view of the screw according to FIG. 3A.

FIG. 3D illustrates the detail A of FIG. 3C.

FIG. 4A illustrates a perspective view of a fourth exemplary embodiment of the new screw having a double contour engagement.

FIG. 4B illustrates a view of the head of the screw according to FIG. 4A from above.

FIG. 4C illustrates a partly sectional side view of the screw according to FIG. 4A.

FIG. 4D illustrates the detail A of FIG. 4C.

FIG. 5A illustrates a perspective view of a fifth exemplary embodiment of the new screw having a double contour engagement.

FIG. 5B illustrates a view of the head of the screw according to FIG. 5A from above.

FIG. 5C illustrates a partly sectional side view of the screw according to FIG. 5A.

FIG. 5D illustrates the detail A of FIG. 5C.

FIG. 6 illustrates a partly broken open and sectional view of an exemplary embodiment of a new deforming tool for producing a screw having a double contour engagement in a position at the beginning of the deforming process.

FIG. 7 illustrates the deforming tool according to FIG. 6 in a position at the end of the deforming process.

FIG. 8 illustrates different deforming stages of the screw during its manufacture.

FIG. 9 illustrates a perspective view of an exemplary embodiment of a new actuation tool for actuating the screw having a double contour engagement.

FIG. 10 illustrates a sectional view of the actuation tool according to FIG. 9 in a first position at the beginning of contact with the head of the screw.

FIG. 11 illustrates a sectional view of the actuation tool according to FIG. 9 in a second position during complete contact to the head of the screw.

FIG. 12 illustrates a perspective view of the actuation tool according to FIG. 9 being cut open in the longitudinal direction.

### DETAILED DESCRIPTION

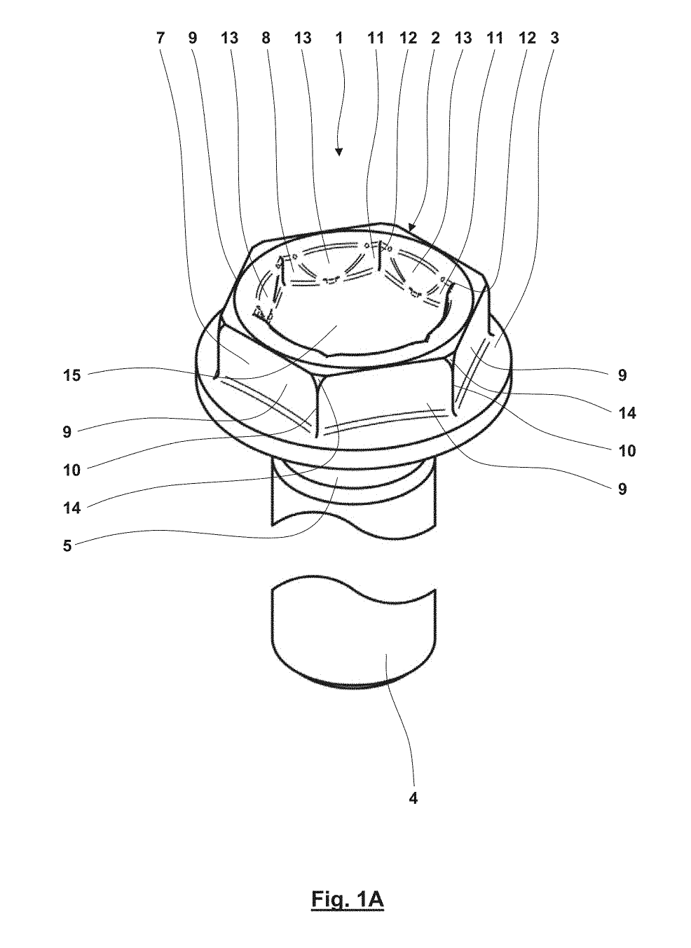

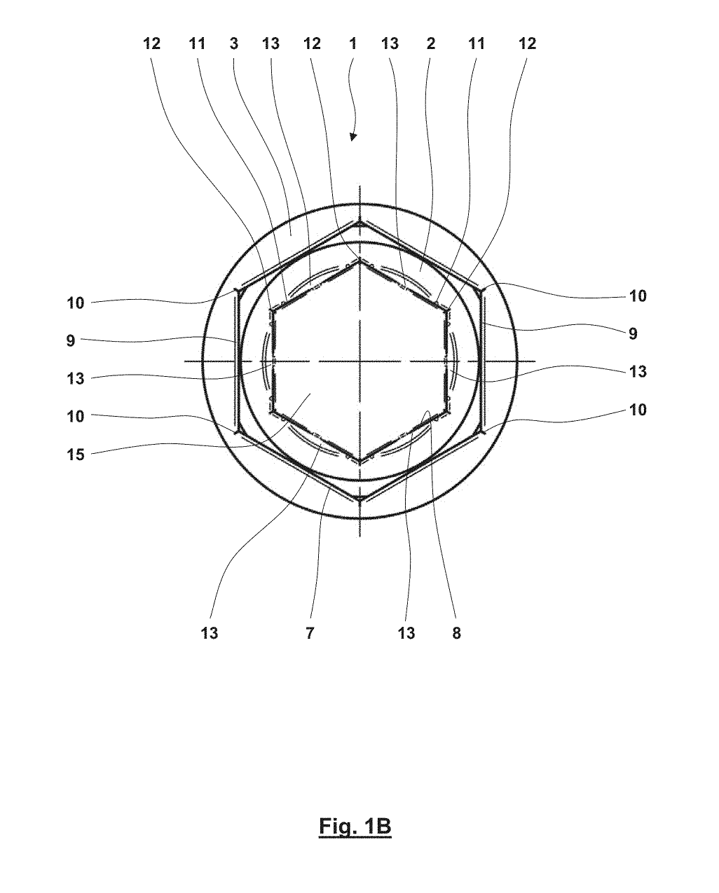

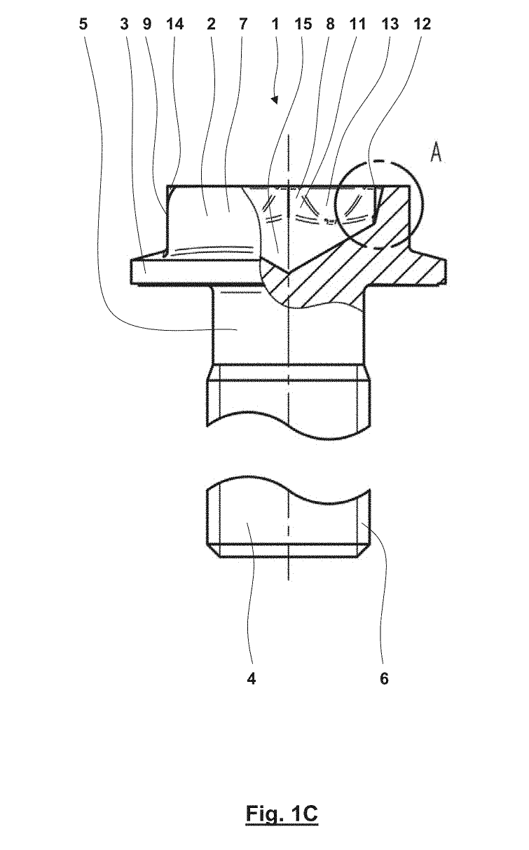

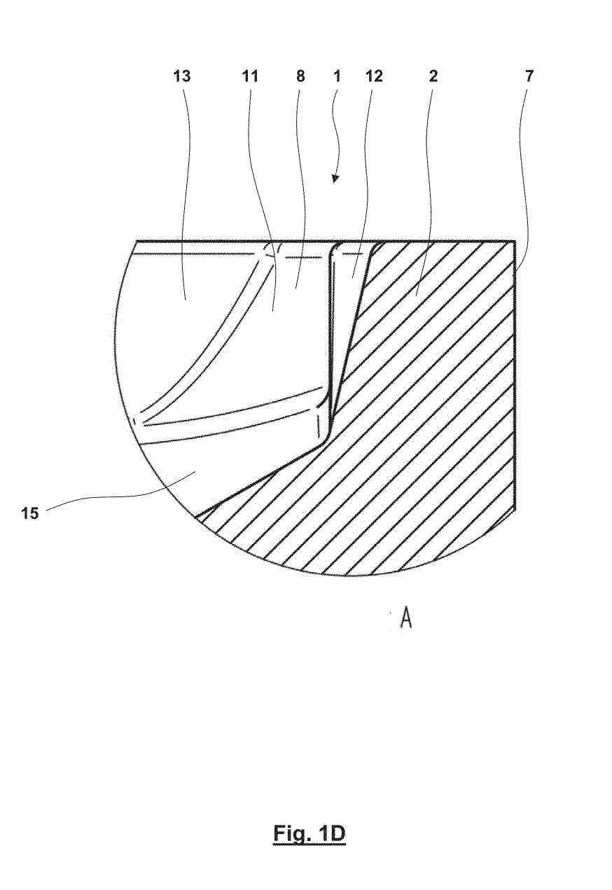

FIGS. 1A-1D illustrate different views of a first exemplary embodiment of a new high-strength screw 1. The screw 1 is a high-strength screw 1 having a tensile strength of at least 800 N/mm², especially an ultra-high-strength screw 1 having a tensile strength of at least 1400 N/mm². The screw 1 includes a bainite structure that has especially been produced by austempering and that extends substantially over the entire cross-section of the screw 1. The same applies to the other embodiments of the screw 1.

The screw 1 includes a head 2, a collar 3 and a shank 4. A threadless shank portion 5 and a threaded portion 6 including an external thread are located at the shank 4. The threadless shank portion 5 could also be omitted. For improving visibility of the details of the head 2 of the screw 1, the shank 4 is partly cut away. Consequently, its entire length is not illustrated. It is to be understood that the shank 4 may have any length and any diameter. The same applies to the other embodiments of the screw 1.

The head 2 of the screw 1 includes an tool engagement external contour 7 and a tool engagement internal contour 8. In the illustrated example, the tool engagement external contour 7 is designed as an external six-edge and the tool engagement internal contour 8 is designed as an internal six-edge. The tool engagement external contour 7 includes a plurality—in this case six—force engagement surfaces 9 being designed as approximately plane surfaces and each being interconnected by corners 10. The tool engagement internal contour 8 also includes a plurality—in this case six—force engagement surfaces 11 being interconnected by corners 12.

The tool engagement internal contour 8 has a special design including of an arrangement of pocket-shaped impressions 13. The pocket-shaped impressions 13 are designed as cold-formed dents located in the respective force engagement surface 11 of the tool engagement internal contour 8. They are arranged approximately centrally between the corners 12 of the tool engagement internal contour 8. They are located next to the axial end of the head 2 facing away from the shank 4. Their width increases in the direction of the axial end of the head 2 facing away from the shank 4. The pocket-shaped impressions 13 do not extend over the entire width of the respective force engagement surface 11 of the tool engagement internal contour 8. The portions of the force engagement surface 11 of the tool engagement internal contour 8 in which no pocket-shaped impressions are arranged serve to transmit torque by the actuation tool for turning the screw 1. The pocket-shaped impressions 13 are arranged approximately centrally between the corners 10 of the tool application external contour 7 in a circumferential direction.

The pocket-shaped impressions 13 serve to dislocate material from this inner region and to let it flow into the outer portions of the corners 10 of the tool engagement external contour 7 during manufacture of the screw 1 by deforming, especially cold-forming. It is desired to fill the corners 10 as much as possible such that the upper portions of the corners 10—i.e. in the axial end of the head 2 facing away from the shank 4—the unfilled corner portions 14 are as small as possible. In this way, it is ensured that the desired torque can be transmitted by the tool engagement external contour 7 as well as the tool engagement internal contour 8. These transmissions may occur alternatively or simultaneously.

The pocket-shaped impressions 13 are to be differentiated from the central impression 15 serving to provide the material for the entire tool engagement internal contour 8.

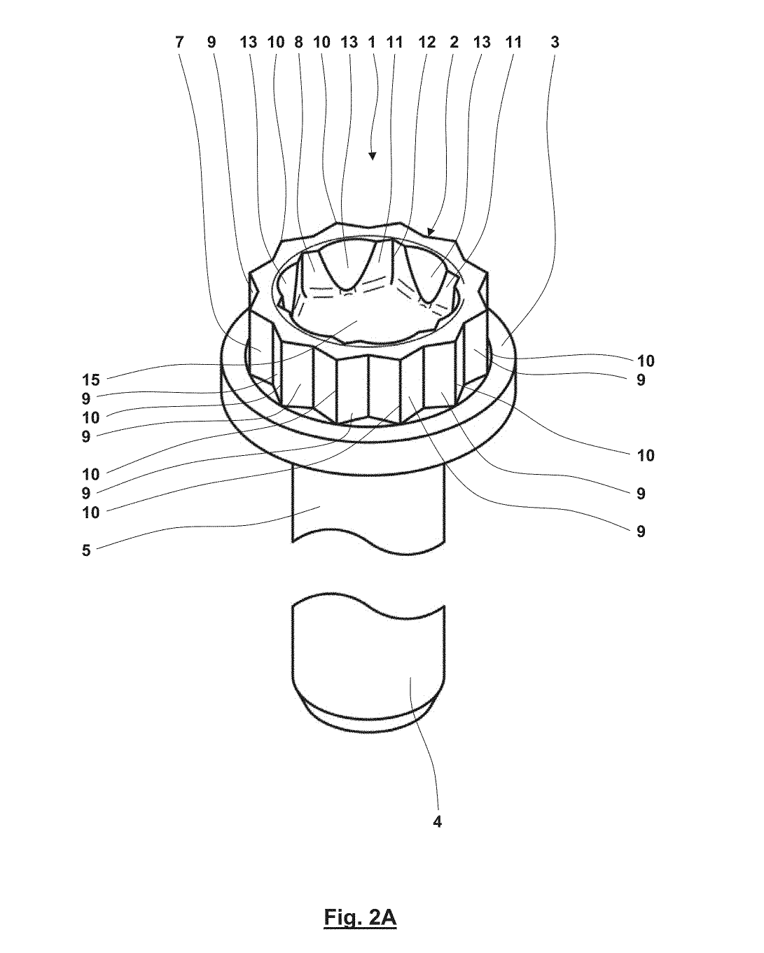

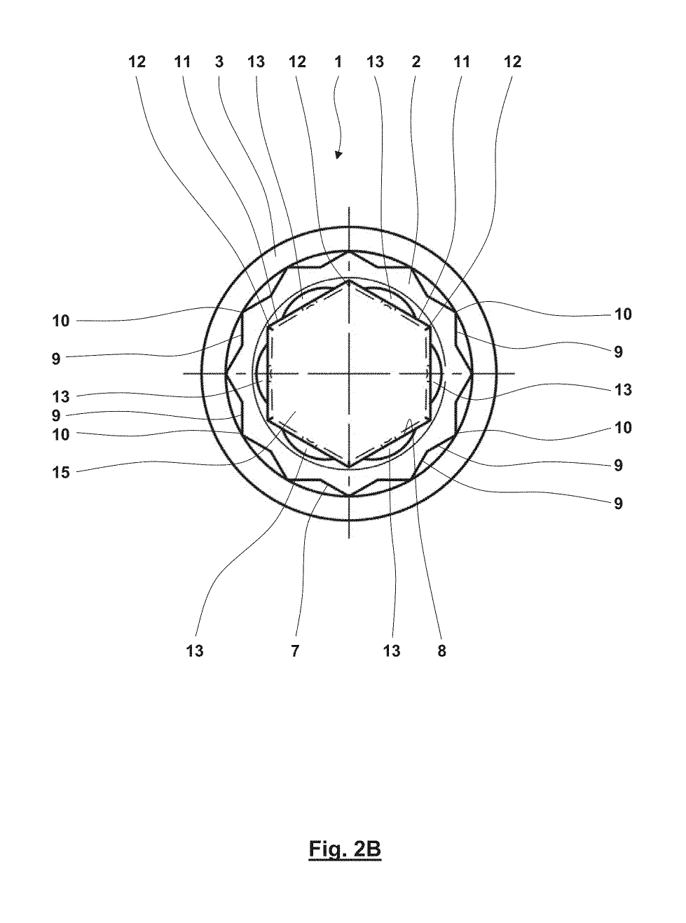

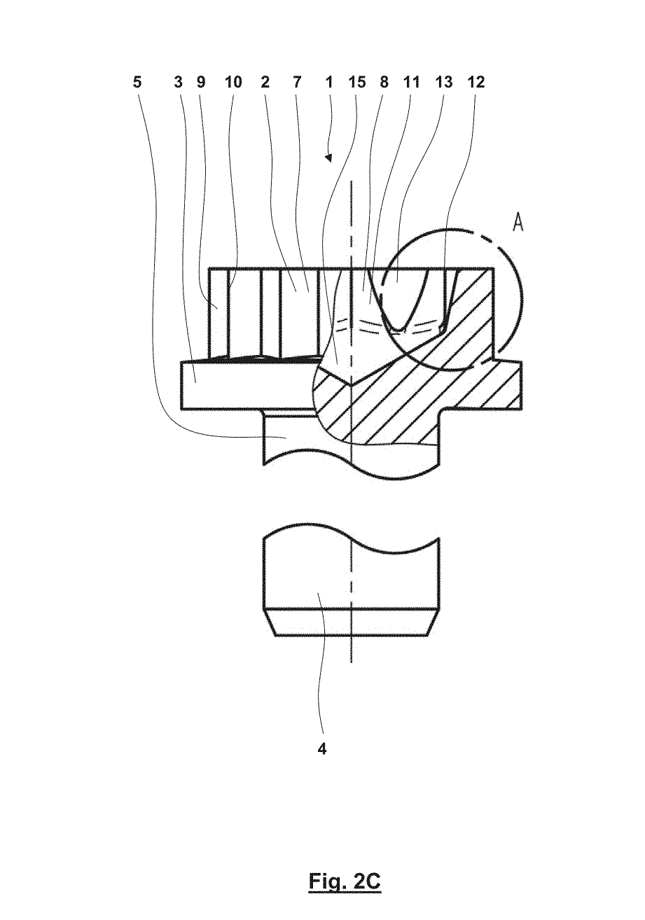

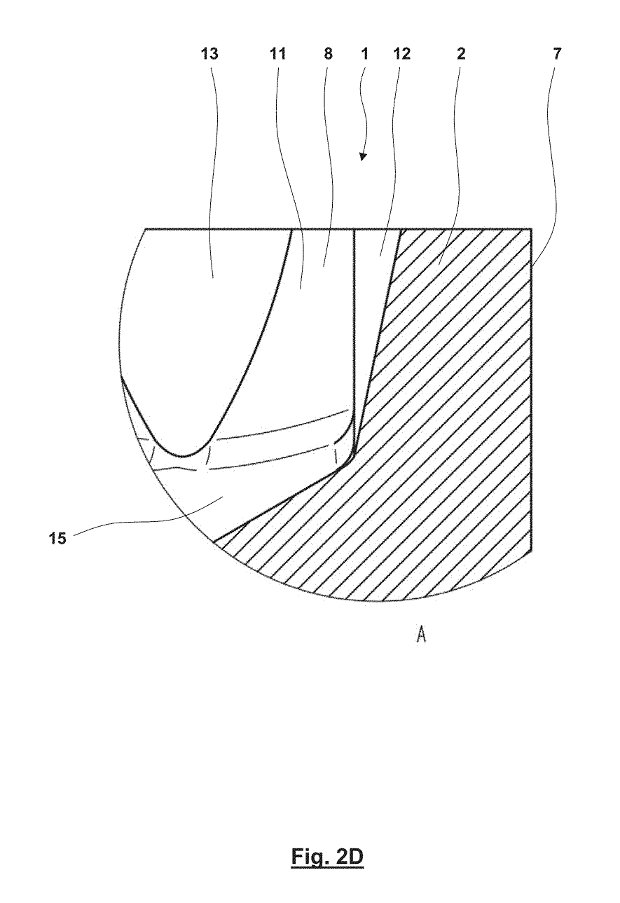

FIGS. 2A-2D illustrate respective views of a second exemplary embodiment of the new screw 1. With respect to the coinciding features, it is referred to the above statements.

In contrast thereto, the tool engagement external contour 7 is designed as an external twelve-edge. In this case, the pocket-shaped impressions 13 are not arranged axially between the corners 10 of the tool engagement external contour 7. Instead, they are arranged radially inward with respect to each other corner 10 of the tool engagement external contour 7.

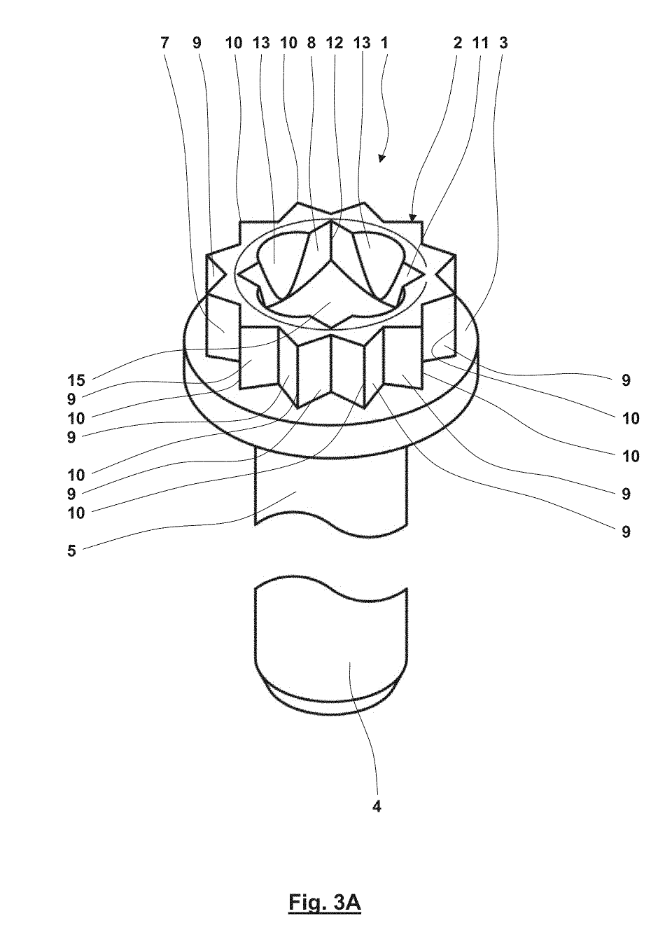

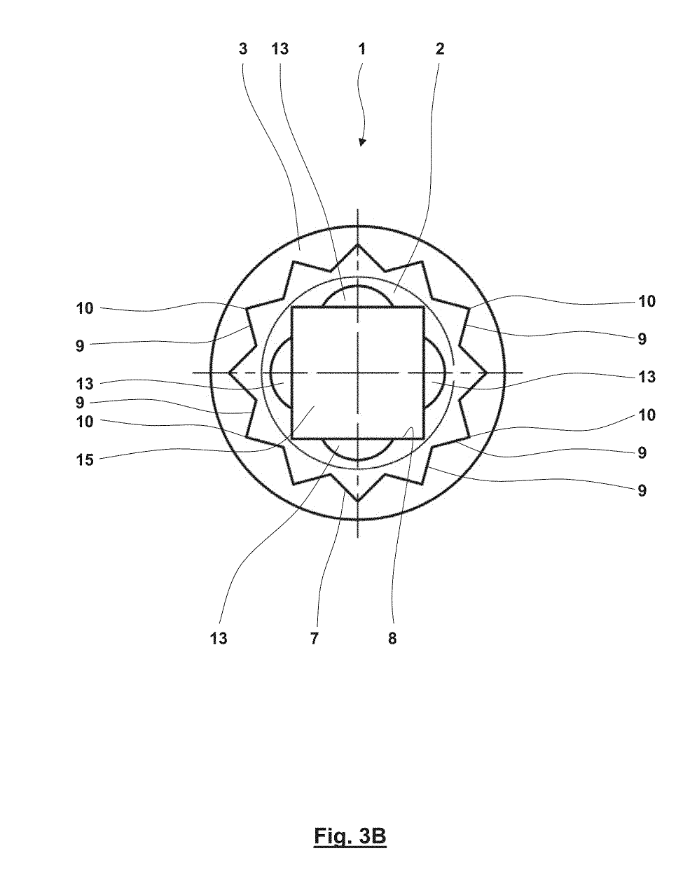

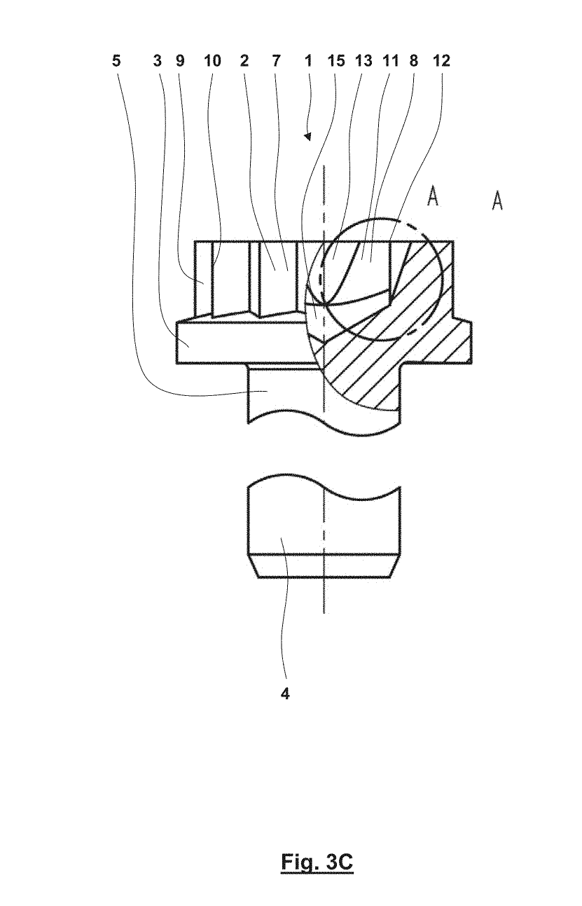

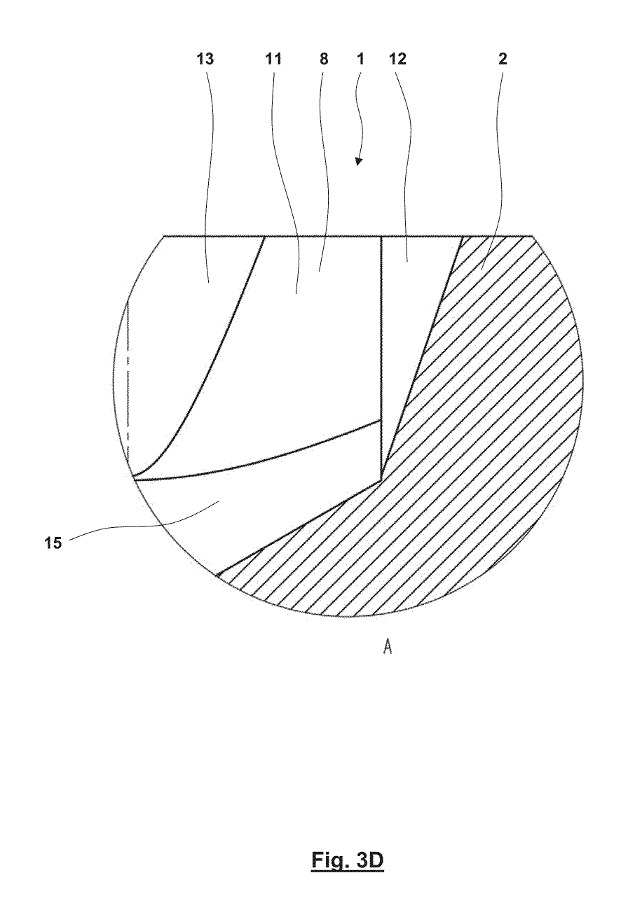

FIGS. 3A-3D illustrate respective views of a third exemplary embodiment of the new screw 1. With respect to the coinciding features, it is referred to the above statements.

In contrast thereto, the tool engagement external contour 7 is designed as an external twelve-tooth. The tool engagement internal contour 8 is designed as an internal four-tooth. The pocket-shaped impressions 13 are each arranged approximately centrally between the corners 12 of the tool engagement internal contour 8. They are arranged radially inward with respect to one corner 10 of the tool engagement external contour 7. In this case, this is every fourth corner 10.

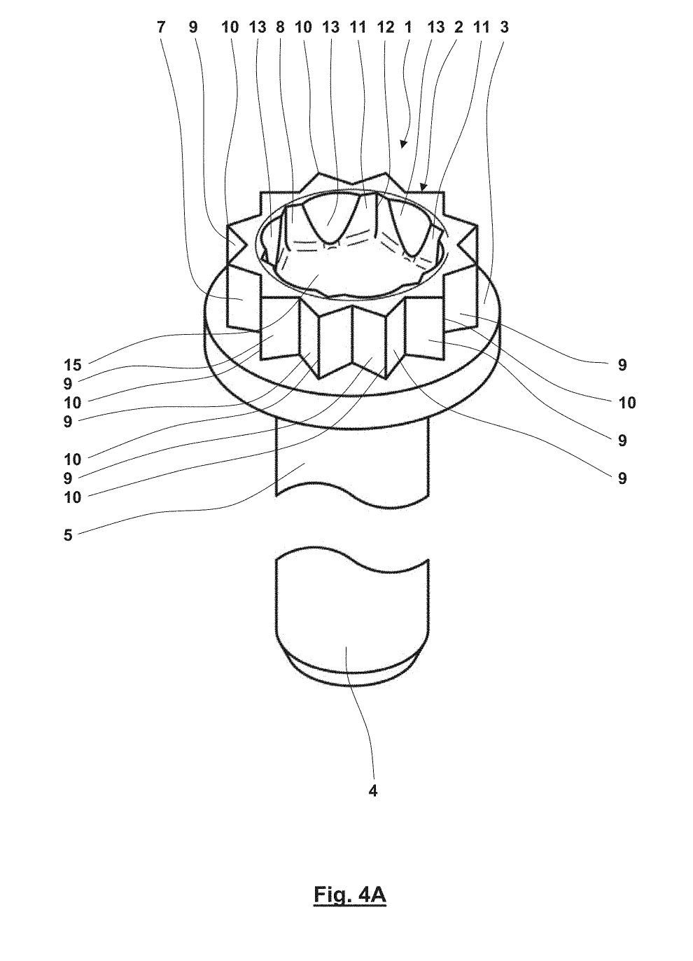

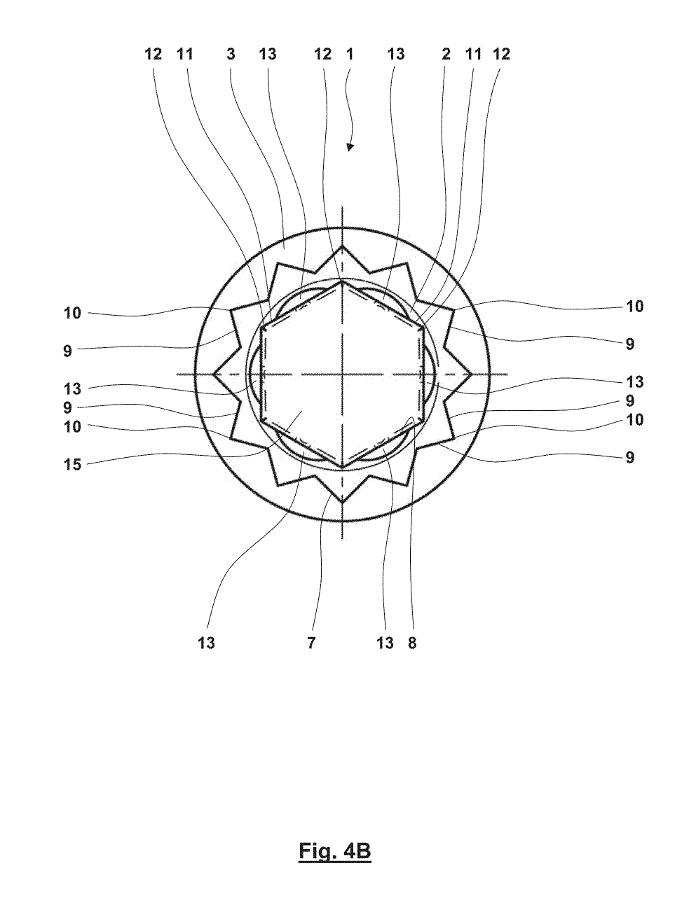

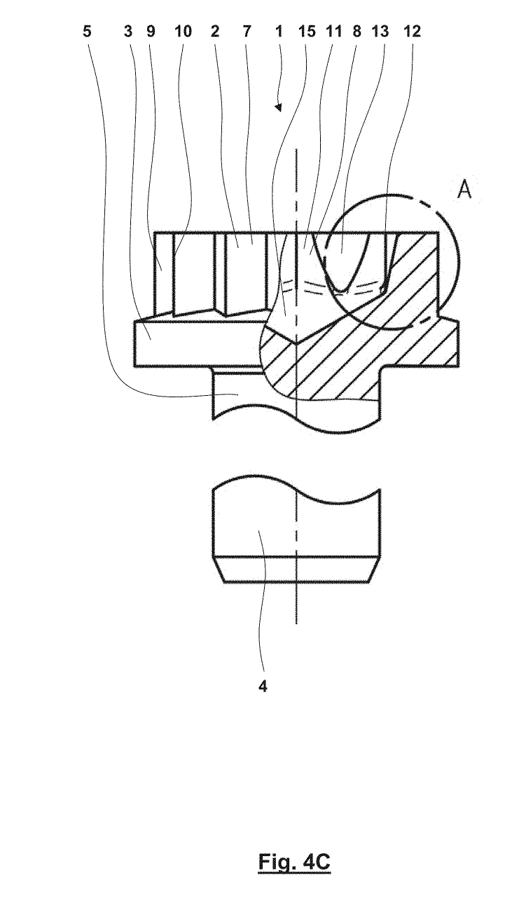

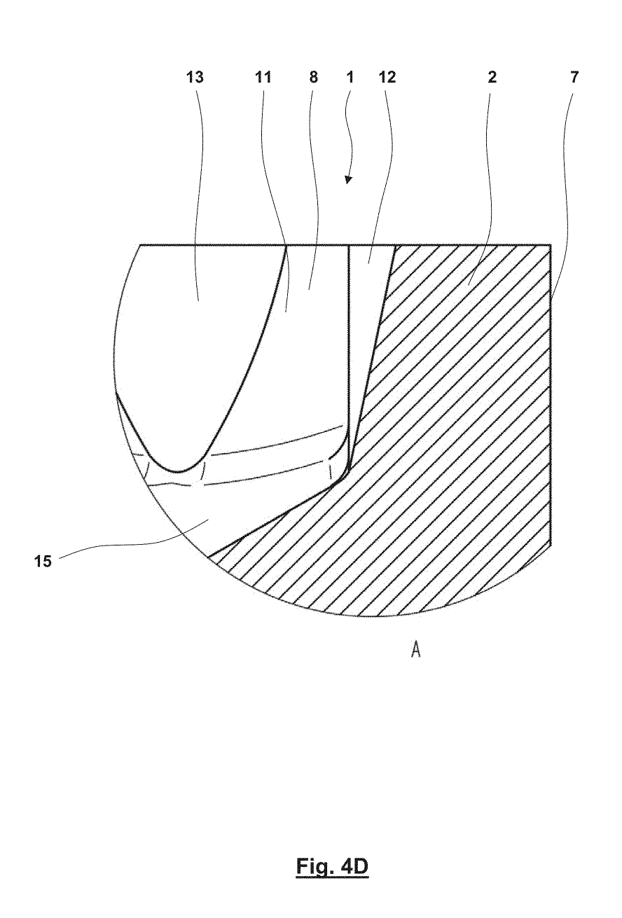

FIGS. 4A-4D illustrate respective views of a fourth exemplary embodiment of the new screw 1. With respect to the coinciding features, it is referred to the above statements.

The tool engagement external contour 7 is once again designed as an external twelve-tooth. The tool engagement internal contour 8 is designed as an internal six-edge. The pocket-shaped impressions 13 are located approximately centrally between the corners 12 of the tool engagement internal contour 8. They are arranged radially inward with respect to every other corner 10 of the tool engagement external contour 7.

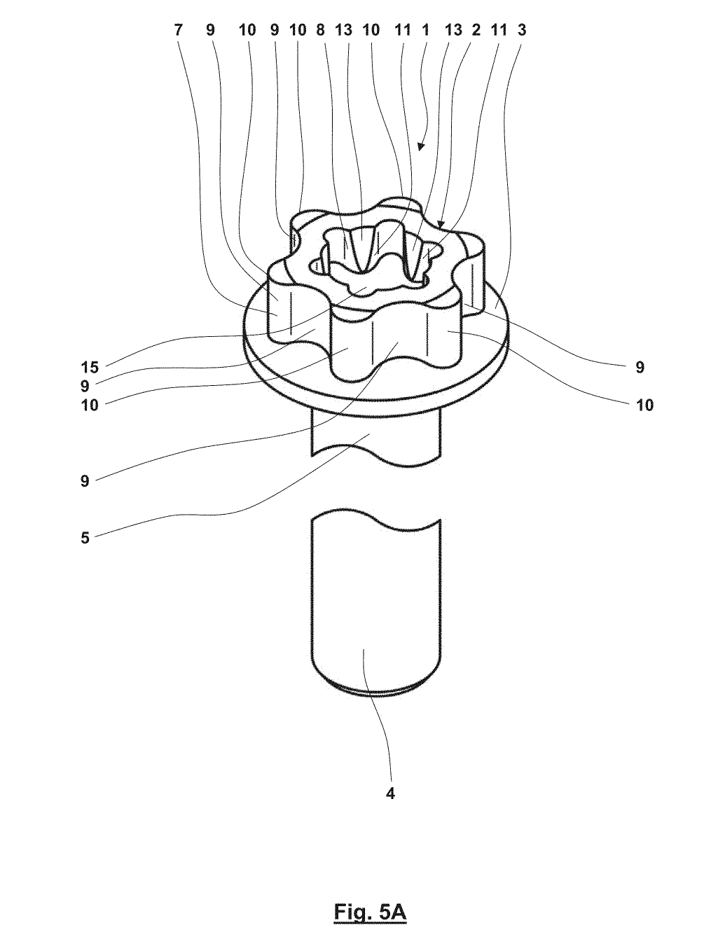

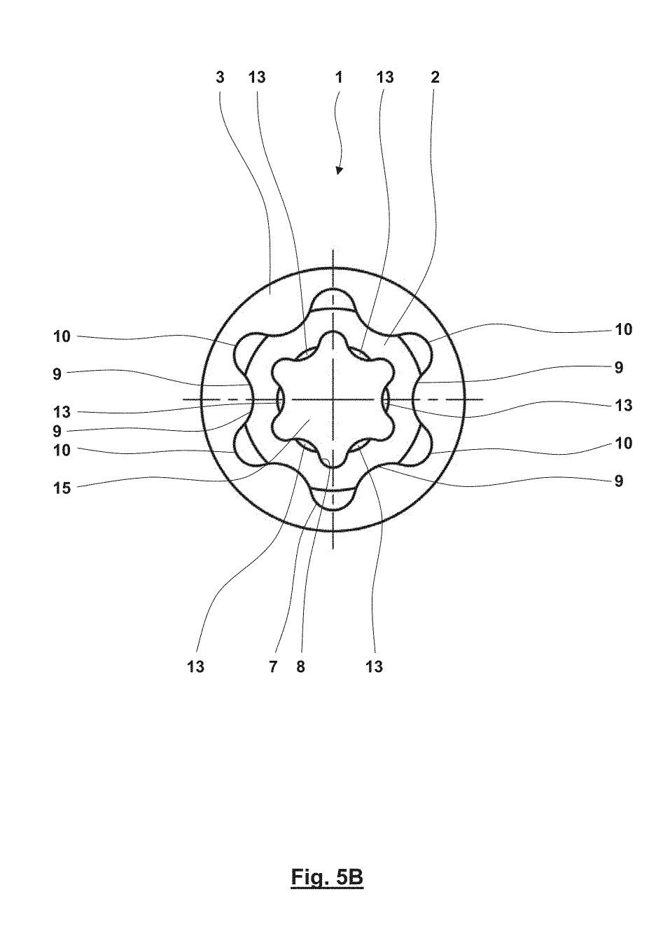

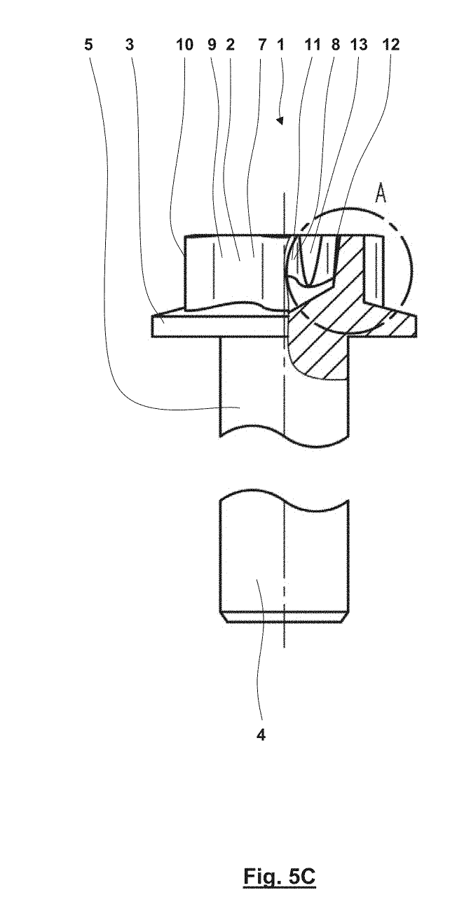

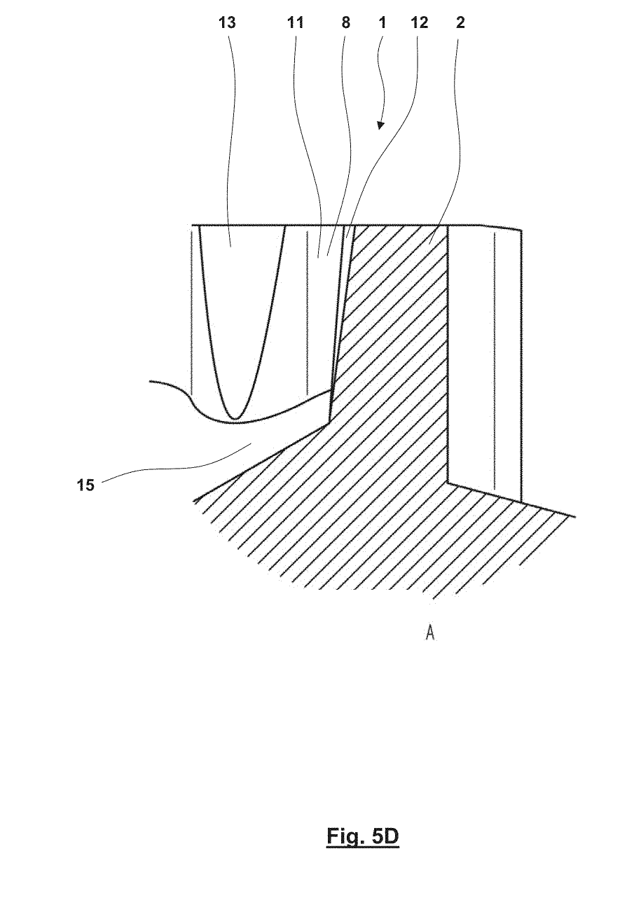

FIGS. 5A-5D illustrate respective views of a fifth exemplary embodiment of the new screw 1. With respect to the coinciding features, it is referred to the above statements.

In contrast thereto, the tool engagement external contour 7 is designed as an external six-round. The tool engagement internal contour 8 is designed as an internal six-round. The force engagement surfaces 9, 11 are thus not substantially plane, but instead rounded or curved. The corners 10, 12 are not substantially straight, but instead rounded. The pocket-shaped impressions 13 are arranged approximately centrally between the rounded corners 12 of the tool engagement internal contour 8 in a circumferential direction. They are also arranged approximately centrally between the corners 10 of the tool engagement external contour 7.

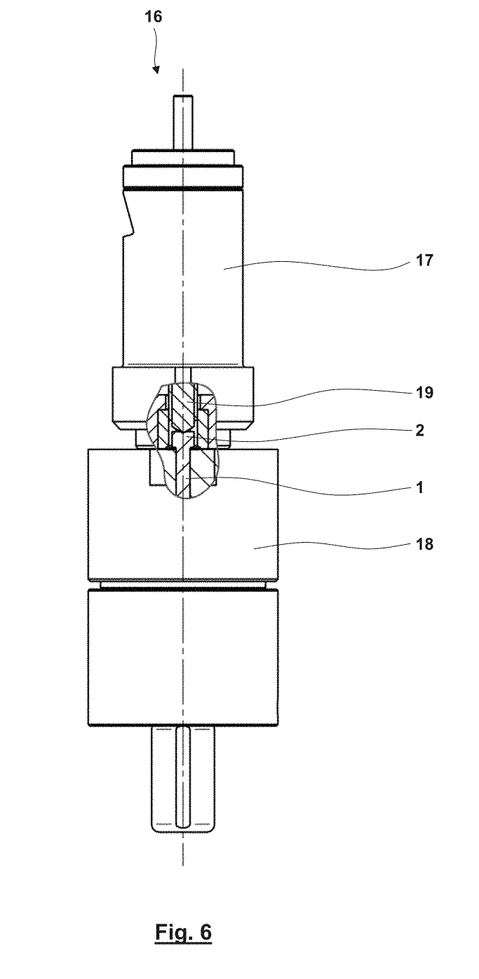

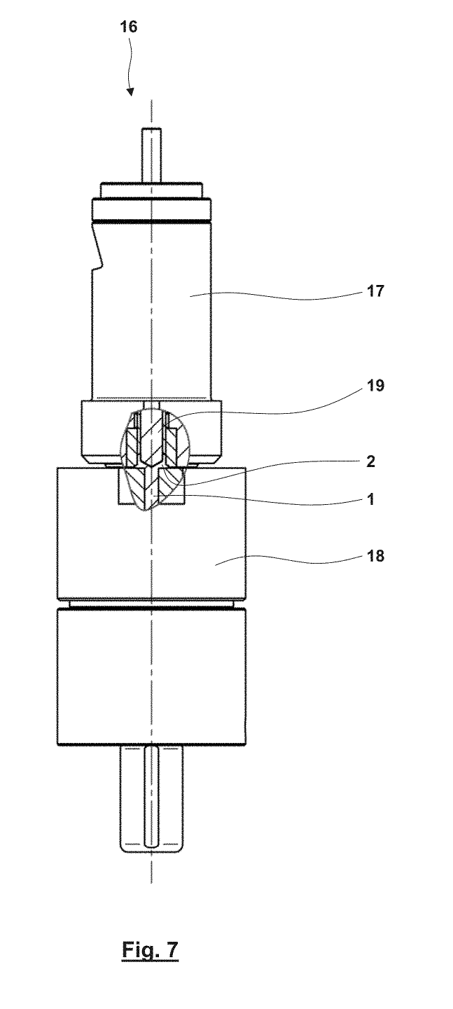

FIGS. 6 and 7 illustrate an exemplary embodiment of a new deforming tool 16 for producing a new screw 1 by deforming, especially cold-forming. The deforming tool 16 is part of a multi-stage press. Since the general structure and functionality of a multi-stage press are known to the skilled person, further statements in this regards are omitted.

The deforming tool 16 includes a stamp tool 17 and a matrix tool 18. The stamp tool 17 includes a stamp 19 being designed to produce the desired shape of the head 2 of the screw 1. The stamp 19 is designed such that it produces the central impression 15 and the tool engagement internal contour 8 with the pocket-shaped impressions 13. The stamp tool 17 is designed such that the tool engagement external contour 7 is simultaneously produced. This progressive process is well comprehensible from a comparison of FIGS. 6 and 7.

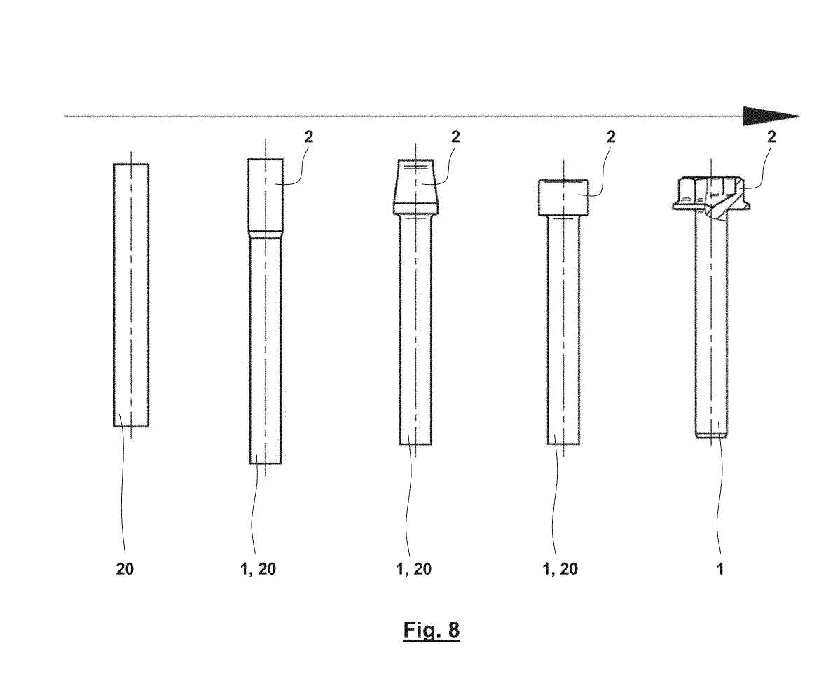

FIG. 8 illustrates different intermediate stages during the deforming process of a blank 20 being designed as a wire section to a screw 1 including a fully completed head 2.

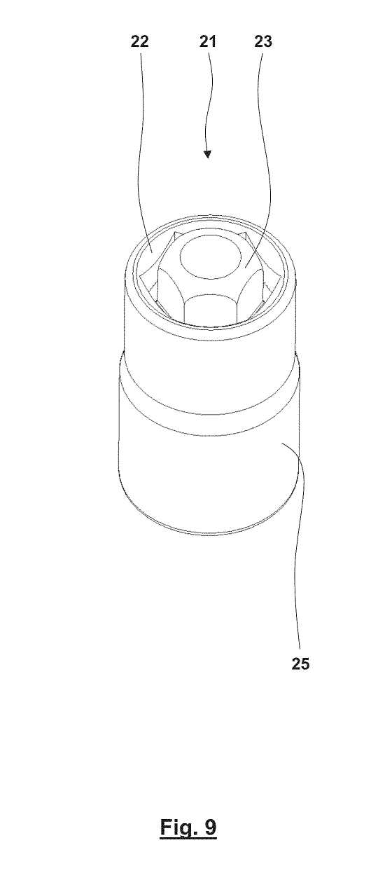

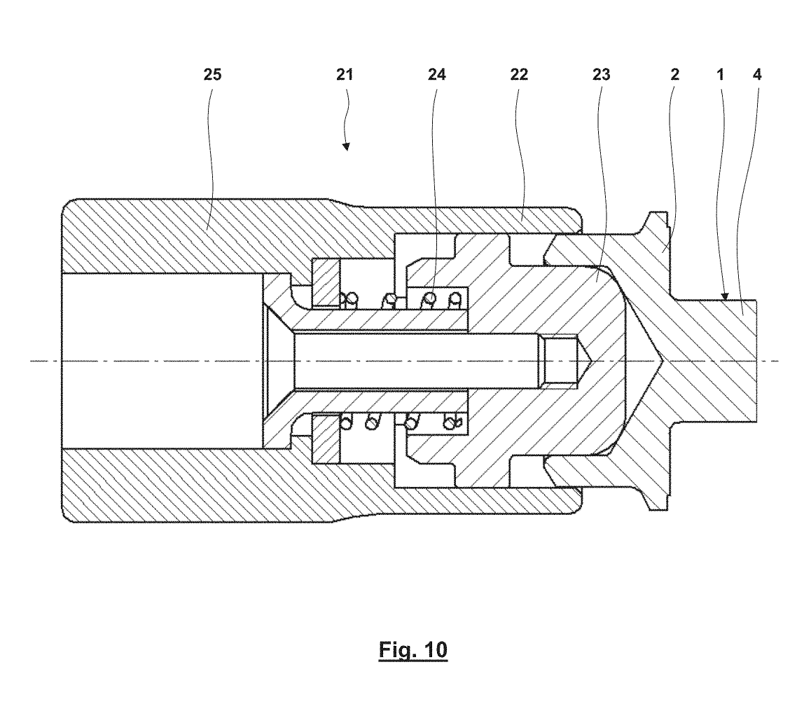

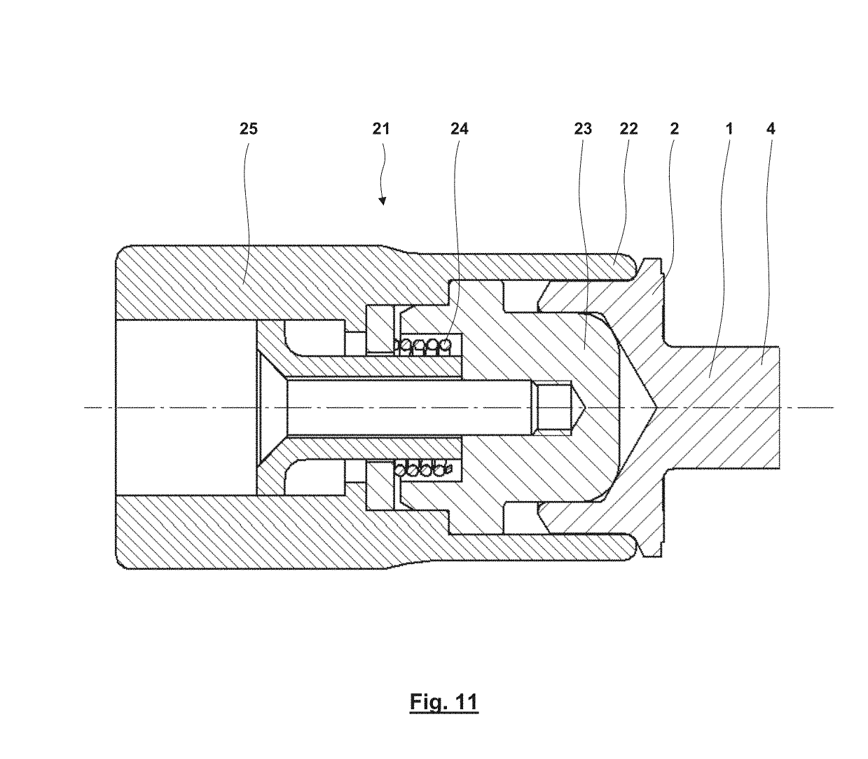

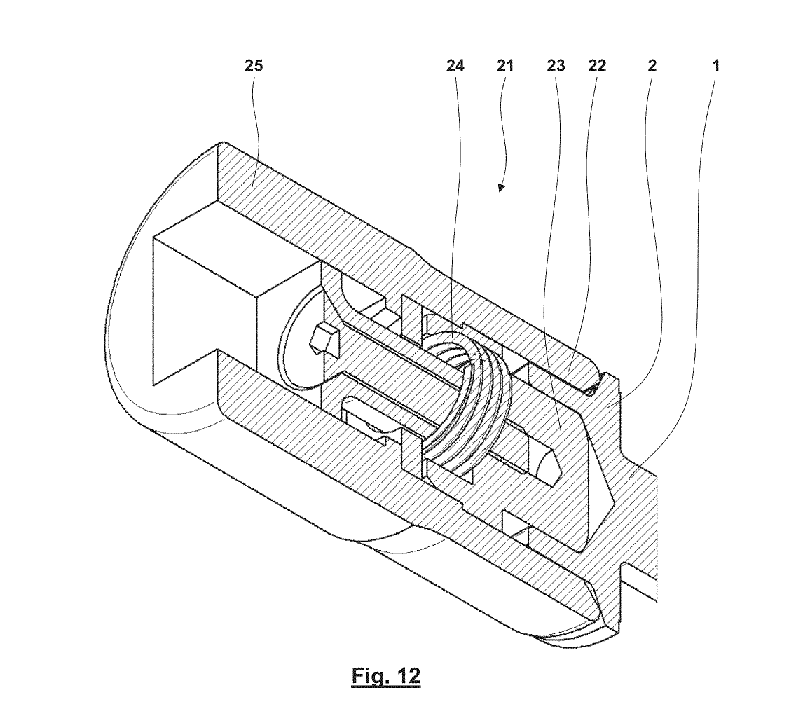

FIGS. 9-12 illustrate different views of an exemplary embodiment of a new actuation tool 21 for turning (rotating) the new screw 1. The actuation tool 21 is mounted in a screwing tool. The screwing tool may be motor-driven or hand-driven.

The actuation tool 21 includes a housing 25 in which an external actuation element 22 for engaging the tool engagement external contour 7 of the screw 1 and an internal actuation element 23 for simultaneously engaging the tool engagement internal contour 8 of the screw 1 are arranged.

The internal actuation element 23 is supported in the housing 25 by a spring 24 to be movable in a translatory direction. The starting position of the spring 24 is illustrated in FIG. 13. The internal actuation element 23 protrudes from the housing 25 in an axial direction. In this way, it serves as an insertion and centering aid when initiating contact between the actuation tool 21 and the head 2 of the screw 1. The internal actuation element 23 is pressed against the force of the spring 24 by the user of the actuation tool 21 resulting in the external actuation element 22 now progressively getting in contact to the tool engagement external contour 7 of the screw 1.

For example, this functionality of the actuation tool 21 may be used in a sense that a contact is closed and an electrical signal is transmitted only after the end position illustrated in FIG. 14 has been reached. The electric signal leads to the motor of the screwing tool being turned on. In this way, actuation of the actuation tool 21 causing the head 2 of the screw 1 to be damaged is prevented before complete contact between the external actuation element 22 and the tool engagement external contour 7 as well as between the internal actuation element 23 and the tool engagement internal contour 8 has been established.

Many variations and modifications may be made to the preferred embodiments of the invention without departing substantially from the spirit and principles of the invention. All such modifications and variations are intended to be included herein within the scope of the present invention, as defined by the following claims.

We claim:

1. A high-strength screw, comprising:
a head, the head having
a tool engagement external contour, and
a tool engagement internal contour, the tool engagement internal contour including a plurality of force engagement surfaces and a plurality of corners, the corners being arranged between the force engagement surfaces; and
a plurality of pocket-shaped impressions, the pocket-shaped impressions being arranged in the tool engagement internal contour, the pocket-shaped impressions not being the force engagement surfaces.

2. The screw of claim 1, wherein the pocket-shaped impressions are arranged approximately centrally between the corners.

3. The screw of claim 1, wherein
the screw includes a shank;
the head has a first axial end facing from the shank; and
the pocket-shaped impressions are located next to the first axial end of the head.

4. The screw of claim 1, wherein the pocket-shaped impressions are designed as cold-formed dents being located in one of the force engagement surfaces of the tool engagement internal contour.

5. The screw of claim 1, wherein
the screw includes a shank;
the head has a first axial end facing from the shank; and
the pocket-shaped impressions have a width, the width increasing in a direction towards the first axial end of the head.

6. The screw of claim 1, wherein
each of the force engagement surfaces has a width; and
the pocket-shaped impressions do not extend over the entire width of the force engagement surfaces.

7. The screw of claim 1, wherein the tool engagement internal contour belongs to one of the following geometry types: multi-edge, multi-tooth and multi-round.

8. The screw of claim 1, wherein the tool engagement internal contour belongs to one of the following geometry types: six-edge, four-tooth and six-round.

9. The screw of claim 1, wherein
the tool engagement internal contour belongs to one of the following geometry types: multi-edge and multi-tooth; and
the pocket-shaped impressions of the tool engagement internal contour are arranged approximately centrally between the corners of the multi-edge or multi-tooth.

10. The screw of claim 1, wherein
the tool engagement internal contour belongs to the geometry type multi-round;
the force engagement surfaces and the corners of the tool engagement internal contour are rounded; and
the pocket-shaped impressions are arranged approximately centrally between the rounded corners of the multi-round.

11. The screw of claim 1, wherein the tool engagement external contour belongs to one of the following geometry types: multi-edge, multi-tooth and multi-round.

12. The screw of claim 1, wherein the tool engagement external contour belongs to one of the following geometry types: six-edge, twelve-edge, twelve-tooth and six-round.

13. The screw of claim 1, wherein
the tool engagement external contour belongs to one of the following geometry types: multi-edge and multi-tooth;
the force engagement surfaces of the tool engagement external contour being plane; and
the pocket-shaped impressions are arranged approximately centrally between the corners of the multi-edge or multi-tooth.

14. The screw of claim 1, wherein
the tool engagement external contour belongs to the geometry type multi-round;
the force engagement surfaces and the corners of the tool engagement external contour are rounded; and
the pocket-shaped impressions are arranged approximately centrally between the rounded corners of multi-round.

15. The screw of claim 1, wherein the tool engagement external contour and the tool engagement internal contour belong to the same geometry type.

16. The screw of claim 15, wherein the geometry type is one of the following: edge, tooth and round.

17. An automatic deforming method for manufacture of a high-strength screw from a blank, comprising the steps of:
deforming the blank in a deforming tool such that a head of a screw having
a tool engagement external contour,
a tool engagement internal contour, the tool engagement internal contour including a plurality of force engagement surfaces and a plurality of corners, the corners being arranged between the force engagement surfaces, and
a plurality of pocket-shaped impressions, the pocket-shaped impressions being arranged in the tool engagement internal contour, the pocket-shaped impressions not being the force engagement surfaces
are produced.

18. The deforming method of claim 17, wherein the blank is deformed by cold-forming such that the screw attains the features of at least one of the preceding claims.

19. A deforming tool for manufacture of a high-strength screw of a blank, comprising:
a stamp tool; and
a matrix tool, the stamp tool and the matrix tool being designed and arranged such that they, when the deforming tool is actuated, deform the blank in a way that a head of a screw having
a tool engagement external contour,
a tool engagement internal contour, the tool engagement internal contour including a plurality of force engagement surfaces and a plurality of corners, the corners being arranged between the force engagement surfaces, and
a plurality of pocket-shaped impressions, the pocket-shaped impressions being arranged in the tool engagement internal contour, the pocket-shaped impressions not being the force engagement surfaces
are produced.

20. An actuation tool for actuating a high-strength screw having a tool engagement external contour and a tool engagement internal contour, comprising:
an external actuation element for engaging the tool engagement external contour of the head of the screw; and
an internal actuation element for simultaneously engaging the tool engagement internal contour of the head of the screw.
